(19) United States
(12) Patent Application Publication
(10) Pub. No.: US 2004/0158969 A1
(43) Pub. Date: Aug. 19, 2004

(54) Method for producing a sheathed penetrator

(75) Inventors: Helmut Ortmann, Duisburg (DE); Stefan Thiesen, Willich (DE); Dieter Jungbluth, Herschbach (DE)

Correspondence Address: VENABLE, BAETJER, HOWARD AND CIVILETTI, LLP, P.O. BOX 34385, WASHINGTON, DC, 20043-9998, US

(73) Assignee: Rheinmetall W & M GmbH, Unterluss (DE)

(21) Appl. No.: 10/776,169

(22) Filed: Feb. 12, 2004

(30) Foreign Application Priority Data
Feb. 12, 2003 (DE) 103 05 721.8

(51) Int. Cl. B23P 17/04

(52) U.S. Cl. 29/592

(57) ABSTRACT

A method is provided for producing a sheathed penetrator having a steel sheath and a heavy-metal core with a smooth surface. The method includes heating the steel sheath to a temperature between 70 and 350° C.; inserting the heavy-metal core into the heated steel sheath; and allowing the steel sheath to cool down. An inside diameter of the steel sheath and an outside diameter of the heavy-metal core are such that an interference fit exists between the steel sheath and the heavy-metal core after the steel sheath has cooled down.

### CROSS REFERENCE TO RELATED APPLICATION

This application claims the priority of German Patent Application, DE 103 05 721.8 filed Feb. 12, 2003 and which is incorporated herein by reference.

### BACKGROUND OF THE INVENTION

The invention relates to a method for producing a sheathed penetrator, comprising a steel sheath and a heavy metal core.

German patent publication DE 22 34 219 C1 is directed to a method for producing a sheathed penetrator, wherein a tubular steel sheath and a tungsten carbide core that is sensitive to breakage are connected by means of a threaded connection. The disadvantage of this method is that on the one hand it is very cost intensive and, on the other hand, installing the external thread on the brittle heavy-metal core considerably increases sensitivity to breakage of this core.

German patent publication DE 39 11 575 A1 is directed to fitting the steel sheath onto the heavy-metal core through surface welding. Apart from the fact that this method also involves a long and cost-intensive production process, it has turned out that when attaching the steel sheath through surface welding, the resulting heat negatively effects the mechanical values and structure of the heavy-metal core.

German patent publication DE 40 16 051 C2 is directed to affixing the steel sheath with the aid of pressure rolling. However, this method also has not succeeded in practical operations because of a number of disadvantages. In particular, the mechanical deformation process can lead to damage to the components. In addition, the machines required for carrying out this method are very cost-intensive.

### SUMMARY OF THE INVENTION

It is an object of the invention to provide a simple and low-cost method for producing a sheathed penetrator, wherein the structure of the heavy-metal core and/or its breaking strength is not, or not essentially, influenced.

This and other objects are achieved according to the invention, in which a method is provided for producing a sheathed penetrator having a steel sheath and a heavy-metal core with a smooth surface. The method includes heating the steel sheath to a temperature between 70 and 350° C.; inserting the heavy-metal core into the heated steel sheath; and allowing the steel sheath to cool down. An inside diameter of the steel sheath and an outside diameter of the heavy-metal core are such that an interference fit exists between the steel sheath and the heavy-metal core after the steel sheath has cooled down.

The invention is based on the idea of initially heating the steel sheath to a temperature between 70 and 350° C., preferably 150° C., and subsequently inserting the heavy-metal core with smooth surface into the heated steel sheath. The steel sheath is then allowed to cool down, which results in an interference fit due to the shrinkage of the steel sheath. In addition, the steel sheath and the heavy-metal core can also be glued together.

The sensitivity to breakage of the heavy-metal core is reduced considerably when a smooth heavy-metal core is used because of the reduction in the notching effect.

The sheathed penetrator that is produced according the inventive method has the advantage that it can be disassembled easily at a later date. To disassemble, the penetrator sheath is heated up again and, once it has sufficiently expanded, is removed from around the heavy-metal core, so that the individual parts can be reused in other applications. In particular, it is possible to insert a different core into the existing sheath (a replacement core). This can be advantageous, for example, if correspondingly improved cores are to be inserted as a result of further developments in penetrator technology or if the penetrator is to be used for different purposes, for example if the threat situation has changed.

It has been proven that it is advantageous if the steel sheath is produced with the powder metallurgy method since this is a very economical method. The powder-based material makes it possible to produce the required geometric dimensions in essentially one operating step, without requiring additional mechanical processing. In addition, a particularly precise coaxial positioning of core and sheath can be achieved. Sheathed penetrators of this type therefore have a particularly trouble-free and non-oscillating flight phase.

However, the steel sheath can also be produced through further processing of a respective solid material.

Additional details and advantages of the invention follow from the exemplary embodiment that is explained in the following with the aid of the Figures.

### BRIEF DESCRIPTION OF THE DRAWINGS

FIG. 1 shows a schematic representation of an example of a first embodiment of the invention; and

FIG. 2 shows a schematic representation of an example of a second embodiment of the invention.

### DETAILED DESCRIPTION OF THE INVENTION

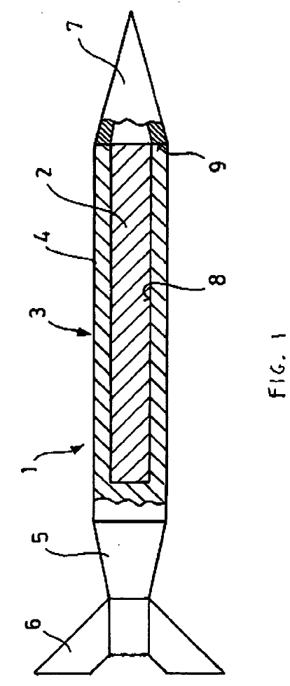

FIG. 1 shows a schematically drawn, fin-stabilized sheathed penetrator 1. The penetrator 1 has, in this example, a tungsten heavy-metal core 2, a steel sheath 3 produced with the powder-metallurgical method, which consists of a tubular main part 4 and, in this example, a solid material rear part 5 onto which a guide assembly 6 is screwed, as well as a ballistic cap 7.

To produce this sheathed penetrator 1, the tubular main part 4 of the steel sheath 3 is initially heated to a temperature between 70 and 350° C., preferably 150° C. Following this, the heavy-metal core 2 that is provided with an extremely smooth surface 8 is inserted into the heated steel sheath 3.

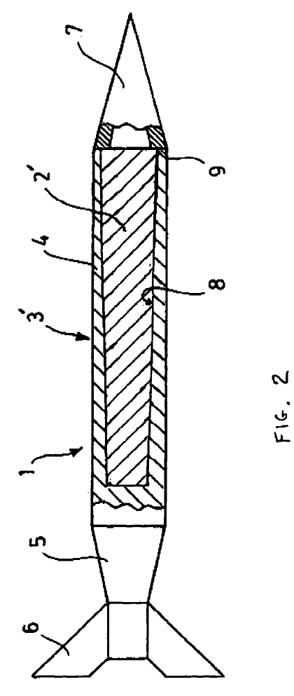

To permit an easier and faster insertion of the heavy-metal core into the steel sheath, it has proven advantageous if the inside diameter of the steel sheath 3 and the outside diameter of the heavy-metal core 2 have a conical shape that opens up slightly toward the front of the penetrator 1. FIG. 2 shows an example of the invention in which the inside diameter of the steel sheath 3′ and the outside diameter of the heavy-metal core 2′ have a conical shape that opens up slightly toward the front of the penetrator 1.

The steel sheath 3, 3′ is then allowed to cool down, so that it shrinks to fit onto the heavy-metal core 2, 2′. The inside diameter of the steel sheath 3, 3′ and the outside diameter of the heavy-metal core 2, 2′ in this case are selected such that the interference fit between the steel sheath 3, 3′ and the heavy-metal core 2, 2′ is sufficiently strong.

Finally, the guide assembly 6 is attached to the rear part 5 of the steel sheath 3, 3′ and the ballistic cap 7 is attached with its inside surface 9 that fits against the projectile body, for example with the aid of glue or friction welding.

The invention is not limited to the above-described exemplary embodiment. For example, it is possible to fashion a tip onto the front of the heavy-metal core and fit the cap over this tip.

It will be apparent, based on this disclosure, to one of ordinary skill in the art that many changes and modifications can be made to the invention without departing from the spirit and scope thereof.

What is claimed is:

1. A method for producing a sheathed penetrator having a steel sheath and a heavy-metal core, the heavy metal core having a smooth surface, the method comprising:
heating the steel sheath to a temperature between 70 and 350° C.;
inserting the heavy-metal core into the heated steel sheath; and
allowing the steel sheath to cool down,
wherein an inside diameter of the steel sheath and an outside diameter of the heavy-metal core are such that an interference fit exists between the steel sheath and the heavy-metal core after the steel sheath has cooled down.

2. The method according to claim 1, wherein the steel sheath is heated to a temperature of approximately 150° C.

3. The method according to claim 1, wherein the steel sheath and the heavy-metal core are additionally connected by glue.

4. The method according to claim 1, wherein the steel sheath is produced with the aid of a powder-metallurgical method.

5. The method according to claim 1, wherein the steel sheath is produced through processing of a respective solid material.

6. The method according to claim 1, wherein the inside diameter of the steel sheath and the outside diameter of the heavy-metal core have a conical shape that has a larger diameter at a front end of the penetrator.

7. The method according to claim 2, wherein the steel sheath and the heavy-metal core are additionally connected by glue.

8. The method according to claim 2, wherein the steel sheath is produced with the aid of a powder-metallurgical method.

9. The method according to claim 2, wherein the steel sheath is produced through processing of a respective solid material.

10. The method according to claim 2, wherein the inside diameter of the steel sheath and the outside diameter of the heavy-metal core have a conical shape that has a larger diameter at a front end of the penetrator.
